(19) United States
(12) Patent Application Publication
(10) Pub. No.: US 2016/0127796 A1
(43) Pub. Date: May 5, 2016

(54) METHODS AND SYSTEMS FOR DETERMINING COMPLIMENTARY OR CONFLICTING AVATARS

(71) Applicant: United Video Properties, Inc., Santa Clara, CA (US)

(72) Inventor: Teresa Wuchter, Tulsa, OK (US)

(21) Appl. No.: 14/526,781

(22) Filed: Oct. 29, 2014

(51) Int. Cl. H04N 21/488; H04N 21/81; H04N 21/45

(52) U.S. Cl. CPC H04N 21/4882; H04N 21/4532; H04N 21/8153

(57) ABSTRACT

Methods and systems are provided herein for providing complimentary or conflicting avatars. In some embodiments, a determination of a need to communicate information to a user is made. When it is determined that a need to communicate information to the user exists, a user profile corresponding to the user may be accessed. Control circuitry may then retrieve a first graphic from the user profile (i.e., the user's selected avatar). In some embodiments, the retrieved graphic may be cross-referenced with a database that lists correspondences between a plurality of graphics. The act of cross-referencing may be used to determine a second graphic that corresponds to the first graphic. When the second graphic is selected, the information that is to be communicated to the user is communicated utilizing the second graphic.

### BACKGROUND

Users often rely on media guidance applications to navigate information about consumable media. Users often personalize or customize a media guidance application to suit their preferences; however, the manner in which media guidance applications may be customized is often limited to user-specified, manual customizations.

### SUMMARY

It is desirable to implement automatic customization of media guidance applications to enhance a user's media guidance experience. Accordingly, systems and methods are described herein for automatically customizing a media guidance application to enhance a user's media guidance experience. More specifically, systems and methods are described herein for automatically customizing how information is communicated to a user. For example, in many cases, information is communicated to a user through the use of on-screen graphics and/or multimedia productions that may represent particular objects or characters. Such on-screen graphics and/or multimedia productions are often a more appealing communicator of information than unformatted text; thus, a user may be more receptive to the information communicated this way.

Furthermore, a user may be more receptive to information communicated by some objects or characters than by other objects or characters. Therefore, the media guidance application may select objects or characters to communicate information based on a likelihood that a user may be receptive to that particular object or character. To do so, the media guidance application may determine particular objects or characters that are liked by or otherwise have some significance to the user as the user may be more receptive to such objects or characters. In some cases, this determination may be based on objects or characters previously selected by the user.

For example, if the media guidance application determines that a user uses a particular avatar for obtaining information, the media guidance application may determine that the user is receptive to receiving information from the object or character that corresponds to the avatar. Furthermore, the media guidance application may determine, with a particular likelihood, that the user will be receptive to information received from an object or character related to that avatar. Thus, the media guidance application may select an avatar that compliments the user-selected avatar, or, alternatively, an avatar that conflicts with a criterion associated with the user-selected avatar (e.g., an antagonist of a media asset for which the user-selected avatar is a protagonist). This automatic selection of a complimentary or conflicting avatar enhances the media guidance experience by allowing complimentary or conflicting avatars to meaningfully convey information to users.

For example, a user who enjoys the movie “Toy Story” may select the character Rex as his avatar. As the user navigates media guidance information, an image or audio rendition of Rex may be used to convey information to the user, such as recommending a movie the user might prefer to watch based on the user profile. There may be instances where a complimentary or conflicting avatar would enhance the user's experience by interacting with the user's avatar, such as when the user attempts to record a show at a time that conflicts with another scheduled recording. In this case, a second avatar, such as Zurg, also from “Toy Story,” may appear, and may communicate to the user that there is a recording conflict.

In accordance with the foregoing, methods and systems are provided herein for providing complimentary or conflicting avatars. In some aspects, control circuitry determines a need to communicate information to a user. The control circuitry's determination may be based on, for example, a user input that requests information (e.g., a user indicating interest in a particular media asset), or an alert that a previously-set condition has been met or is affected by a user action (e.g., a program reminder is to be communicated, or a recording conflict is to be communicated).

When the control circuitry determines that a need to communicate information to the user exists, the control circuitry may access a user profile corresponding to the user. For example, the user profile may contain information expressly input by the user (e.g., name, age, selected avatar, etc.) or information determined by control circuitry (e.g., user preferences, user habits, etc.). Control circuitry may then retrieve a first graphic from the user profile (i.e., the user's selected avatar). For example, if a user selected Rex to be the user's avatar, a graphic of Rex may be retrieved.

Control circuitry may then cross-reference the retrieved graphic with a database that lists correspondences between a plurality of graphics. For example, the database may list correspondences between the retrieved graphic of Rex and any other related graphics. Continuing with this example, one listed correspondence may be that Rex is in conflict with Zurg, who is an enemy of Rex in the movie “Toy Story.” Another listed correspondence may be that Rex is friendly with Woody, who is a fellow protagonist in the movie “Toy Story.” Control circuitry may use the act of cross-referencing to determine a second graphic that corresponds to the first graphic. The act of determination may depend on what the need to communicate to the user is (e.g., select a graphic of a character that is friendly with the user's avatar when the information to be communicated compliments information communicated by the user's avatar; select a graphic of a character that is in conflict with the user's avatar when the information to be communicated conflicts with information communicated by the user's avatar). When the control circuitry selects the second graphic, control circuitry may communicate the information that is to be communicated to the user utilizing the second graphic. For example, control circuitry may generate for display a text string in the vicinity of an avatar using the second graphic, or control circuitry may cause audio corresponding to the character depicted in the second graphic to be transmitted.

In some embodiments, control circuitry may determine the need to communicate information to the user based on receipt of a user request for the information. For example, if control circuitry detects a user request for a television to tune to a broadcast channel playing a movie asset, control circuitry may determine a need to convey information if a different media asset is being broadcast at the same time that the control circuitry determines to be of interest to the user. In this situation, control circuitry may utilize the second graphic to generate for display an avatar, and utilize the avatar to communicate the conflicting information to the user. For example, if a user attempts to tune to the movie “Trains, Planes, and Automobiles,” control circuitry may discover a tuner conflict, and may display Zurg to inform the user that the user usually watches a different show that is broadcast at the same time, and ask the user if the user would like the movie or the different show to be recorded.

In some embodiments, control circuitry may generate the first graphic for display when the user publishes content through a social network. For example, control circuitry may detect a user selection of the first graphic for use in distinguishing the user from other users (e.g., select Rex as an avatar with which the user identifies). In each such case, control circuitry may generate for display the user's avatar when control circuitry determines a user's desire to publish content (e.g., the user posts content such as a “tweet” on Twitter). In these instances, control circuitry may utilize an avatar based on a determined second graphic to convey information to the user if control circuitry determines that there is a need to communicate information.

In some embodiments, the correspondences of the database may include a correspondence indicating that both the first graphic and the second graphic correspond to an identical media asset. For example, Rex from “Toy Story” may be said to correspond with Woody from “Toy Story” because both Rex and Woody starred in the movie “Toy Story.” A further indication may be included in the list of correspondences that Rex and Woody compliment each other, as they are both protagonists in the movie “Toy Story.” Similarly, the first and second graphics may be indicated as corresponding in the database if the first and second graphics correspond to an identical sport. As an example, if the first graphic is of Eli Manning, who is a football player on the New York Giants team, the database may correspond a graphic of the football player Nick Foles of the Philadelphia Eagles as a potential second graphic that corresponds with Eli Manning because both Eli Manning and Nick Foles play football in the National football League. The database may additionally show a correspondence that Nick Foles conflicts with Eli Manning because the Philadelphia Eagles are rivals of the New York Giants.

In some embodiments, control circuitry may determine that the first graphic corresponds to the second graphic when both the first and second graphics correspond to an identical category of interests of the user. For example, if control circuitry determines that the user is interested in cartoon characters and the first graphic is Rex from “Toy Story,” control circuitry may select the second graphic to be any other cartoon character from any other media asset featuring a cartoon character.

In some embodiments, control circuitry may determine a characteristic of the first graphic, and may compare the characteristic to characteristics of the second graphic. For example, a characteristic of Rex from “Toy Story” is that Rex is a dinosaur. Control circuitry may consult characteristics of a second graphic to determine whether the second graphic is also a dinosaur or is associated with a dinosaur (i.e., whether there is a matching characteristic). For example, control circuitry may determine that a dinosaur poacher from the movie “Jurassic Park” corresponds to Rex from the movie “Toy Story” because the dinosaur poacher and Rex share the characteristic of being related to dinosaurs. Control circuitry may also determine the dinosaur poacher to conflict with Rex, as control circuitry may determine that the dinosaur poacher's role in “Jurassic Park” is threatening to dinosaurs like Rex.

In some embodiments, control circuitry may determine an information type of the information to be communicated. An information type may correspond to whether the information to be communicated is an alert (e.g., an alerting of a recording conflict), requested information (e.g., requested programming information), and the like. Control circuitry may cross-reference the information type with the database to determine whether the information type matches an information type corresponding to the second graphic, where, if a match is found, then the control circuitry selects the second graphic for communicating the information. As an example, if the information type is an alert of a conflict, control circuitry may select the second graphic that corresponds to the information type to be of a character that conflicts with the first graphic (e.g., select Zurg to announce the conflict if the user's avatar is Rex).

In some embodiments, control circuitry may cross-reference a current time period with the database for the purpose of identifying the second graphic. If the control circuitry determines that the user's selected avatar or the automatically selected avatar is Rex from the “Toy Story” franchise, and the “Toy Story” franchise is currently at a third feature-length film, the control circuitry may determine to automatically update the avatar such that the avatar appears as Rex appeared in the third feature-length film (as opposed to a previous feature-length film).

It should be noted that the systems and/or methods described above may be applied to, or used in accordance with, other systems, methods and/or apparatuses.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative embodiment of a display screen that may be used to provide media guidance application listings and other media guidance information, in accordance with some embodiments of the disclosure;

FIG. 2 shows another illustrative embodiment of a display screen that may be used to provide media guidance application listings, in accordance with some embodiments of the disclosure;

FIG. 3 is a block diagram of an illustrative user equipment (UE) device in accordance with some embodiments of the disclosure;

FIG. 4 is a block diagram of an illustrative media system in accordance with some embodiments of the disclosure;

FIG. 5 shows an illustrative embodiment of a display screen that may be used to provide media guidance information by way of one or more avatars, in accordance with some embodiments of the disclosure;

FIG. 6 is a flowchart of illustrative steps involved in determining an avatar for use in communicating information to a user, in accordance with some embodiments of the disclosure; and

FIG. 7 is a flowchart of illustrative steps involved in determining whether to use a user-selected or automatically-selected avatar to communicate information, in accordance with some embodiments of the disclosure.

### DETAILED DESCRIPTION

Systems and methods are described herein for communicating information to a user. In some embodiments, the user has specified an avatar for obtaining information, where an avatar that compliments or conflicts with the user-selected avatar is automatically selected based on the user-selected avatar. This automatic selection of a complimentary or conflicting avatar enhances the media guidance experience by allowing complimentary or conflicting avatars to meaningfully convey information to users.

For example, a user who enjoys the movie “Toy Story” may select the character Rex as his avatar. As the user navigates media guidance information, an image or audio rendition of Rex may be used to convey information to the user, such as recommending a movie the user might prefer to watch based on the user profile. There may be instances where a complimentary or conflicting avatar would enhance the user's experience by interacting with the user's avatar, such as when the user attempts to record a show at a time that conflicts with another scheduled recording. In this case, a second avatar, such as Zurg, from “Toy Story,” may appear, and may communicate to the user that there is a recording conflict.

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

The media guidance application and/or any instructions for performing any of the embodiments discussed herein may be encoded on computer readable media. Computer readable media includes any media capable of storing data. The computer readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, Random Access Memory (“RAM”), etc.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase “media guidance data” or “guidance data” should be understood to mean any data related to content or data used in operating the guidance application. For example, the guidance data may include program information, guidance application settings, user preferences, user profile information, media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

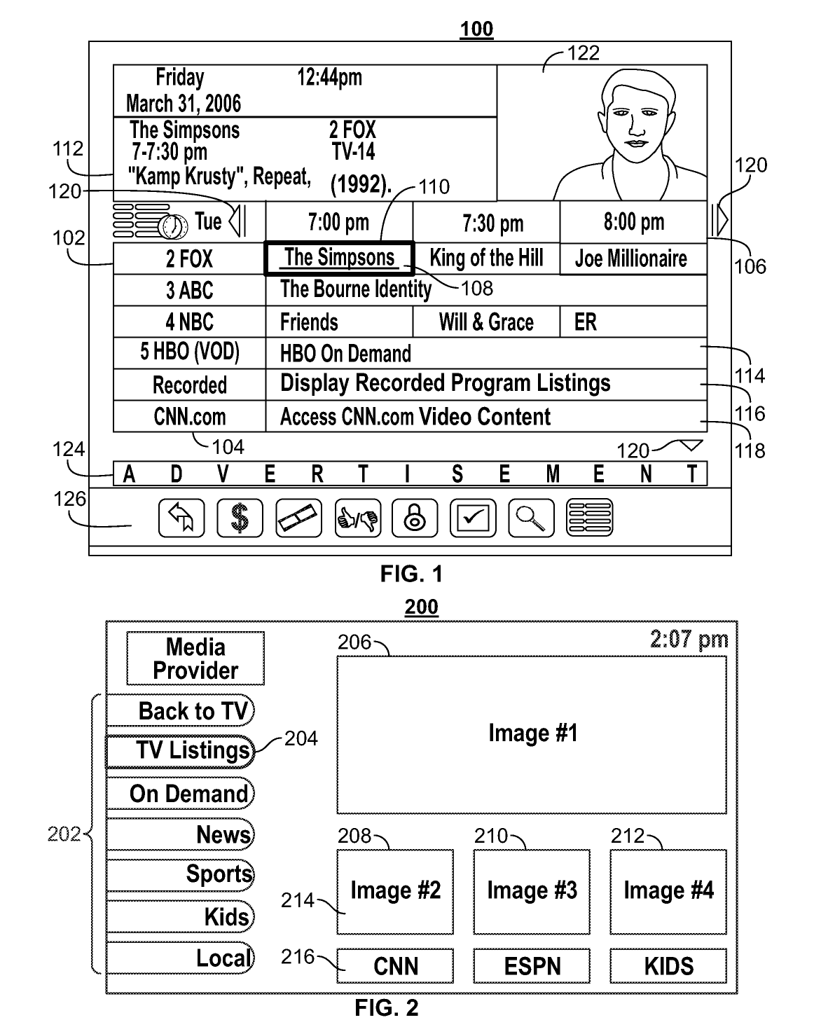

FIGS. 1-2 show illustrative display screens that may be used to provide media guidance data. The display screens shown in FIGS. 1-2 may be implemented on any suitable user equipment device or platform. While the displays of FIGS. 1-2 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria.

FIG. 1 shows illustrative grid of a program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.) Media guidance data may include correspondences of listings, avatar information, or avatars themselves, as described above and below.

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases. Advertisement 124 may be communicated by an avatar consistent with how information is described to be communicated by an avatar above and below.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options (e.g., options to transport or duplicate avatar 502 and/or avatar 504 to a second screen device), options to access various types of media guidance data displays, options to subscribe to a premium service, options to edit a user's profile, options to access a browse overlay, or other options. Options of options region 126 may be communicated by an avatar consistent with how information is described to be communicated by an avatar above and below.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on). Any element of FIG. 2, including regions 202, 204, 206, 208, 210, 212, 214, and 216, may be communicated by an avatar consistent with how information is described to be communicated by an avatar above and below.

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

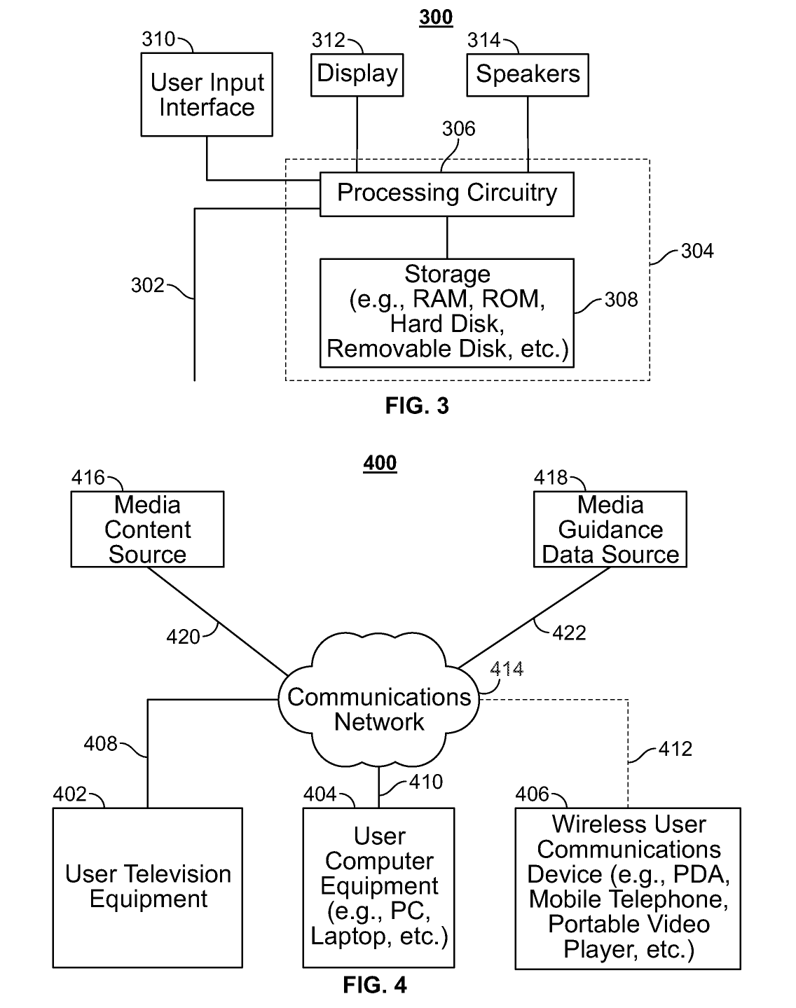

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance data described above. For example, storage 308 may store an avatar or database listing correspondence, as described above and below. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. For example, display 312 may be a touchscreen or touch-sensitive display. In such circumstances, user input interface 310 may be integrated with or combined with display 312. Display 312 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly-implemented on user equipment device 300. In such an approach, instructions of the application are stored locally (e.g., in storage 308), and data for use by the application is downloaded on a periodic basis (e.g., from an out-of-band feed, from an Internet resource, or using another suitable approach). Control circuitry 304 may retrieve instructions of the application from storage 308 and process the instructions to generate any of the displays discussed herein. Based on the processed instructions, control circuitry 304 may determine what action to perform when input is received from input interface 310. For example, movement of a cursor on a display up/down may be indicated by the processed instructions when input interface 310 indicates that an up/down button was selected.

In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server. For example, the remote server may store the instructions for the application in a storage device. The remote server may process the stored instructions using circuitry (e.g., control circuitry 304) and generate the displays discussed above and below. The client device may receive the displays generated by the remote server and may display the content of the displays locally on equipment device 300. This way, the processing of the instructions is performed remotely by the server while the resulting displays are provided locally on equipment device 300. Equipment device 300 may receive inputs from the user via input interface 310 and transmit those inputs to the remote server for processing and generating the corresponding displays. For example, equipment device 300 may transmit a communication to the remote server indicating that an up/down button was selected via input interface 310. The remote server may process instructions in accordance with that input and generate a display of the application corresponding to the input (e.g., a display that moves a cursor up/down). The generated display is then transmitted to equipment device 300 for presentation to the user.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device (e.g., by transporting or duplicating avatar 502 and/or avatar 504 to the second screen device). The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired).

Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412.

Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

In some embodiments, the media guidance data may include viewer data. For example, the viewer data may include current and/or historical user activity information (e.g., what content the user typically watches, what times of day the user watches content, whether the user interacts with a social network, at what times the user interacts with a social network to post information, what types of content the user typically watches (e.g., pay TV or free TV), mood, brain activity information, etc.). The media guidance data may also include subscription data. For example, the subscription data may identify to which sources or services a given user subscribes and/or to which sources or services the given user has previously subscribed but later terminated access (e.g., whether the user subscribes to premium channels, whether the user has added a premium level of services, whether the user has increased Internet speed). In some embodiments, the viewer data and/or the subscription data may identify patterns of a given user for a period of more than one year. The media guidance data may include a model (e.g., a survivor model) used for generating a score that indicates a likelihood a given user will terminate access to a service/source. For example, the media guidance application may process the viewer data with the subscription data using the model to generate a value or score that indicates a likelihood of whether the given user will terminate access to a particular service or source. In particular, a higher score may indicate a higher level of confidence that the user will terminate access to a particular service or source. Based on the score, the media guidance application may generate promotions and advertisements that entice the user to keep the particular service or source indicated by the score as one to which the user will likely terminate access.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

The term “avatar” as used herein is defined to mean any depiction, graphic, or representation of an entity. The entity may be a person or organization (e.g., in which the avatar appears next to posts, descriptions, or profiles associated with the person or organization). Alternatively, the entity may be incorporated into a computer and/or media guidance application (e.g., in which the avatar appears as an intelligent assistant that provides information such as user-guidance, training, trouble-shooting, available options, etc.). In some embodiments, the depiction, graphic, or representation of the avatar may be associated with a particular character, person, mood, or style as derived by the systems and methods of this disclosure.

The terms “avatar” and “graphic” are used interchangeably throughout this disclosure and carry the same weight and meaning. As described above and below, an avatar may be selected either manually or automatically. An avatar that is manually selected by a user is utilized to represent a user (e.g., by uniquely identifying the user on, e.g., a social network). An avatar that is automatically selected may, similar to a manually selected avatar, be used to uniquely identify a user. Generally, an automatically selected avatar is chosen because it corresponds to a user-selected avatar. As used herein, two avatars “correspond” if the avatars share one or more characteristics. For example, two avatars may both be associated with a particular media asset, genre, sport, activity, geographical region, demographic group, color palette, brand, species, user preference, and/or any other suitable characteristics.

An automatically chosen avatar that corresponds to a user-selected avatar may “compliment” or “conflict” with the user-selected avatar. An avatar that “compliments” a user-selected avatar is an avatar that shares one or more characteristics with the user-selected avatar and is selected to provide information that supplements information provided by the user-selected avatar. An avatar that “conflicts” with a user-selected avatar is an avatar that shares one or more characteristics (e.g., the avatars are both associated with the same media asset) with the user-selected avatar, but also has a characteristic that is opposed to a characteristic of the user-selected avatar (e.g., if the user-selected avatar is a protagonist of the media asset, the automatically-selected avatar may be an antagonist of the media asset), and is selected to provide information different from the information provided by the user-selected avatar.

To determine whether or not a first avatar corresponds to a second avatar, control circuitry 304 may determine one or more characteristics about each avatar. For example, as discussed below, control circuitry 304 may identify the first avatar and cross-reference the first avatar with a database listing other avatars to which the first avatar corresponds. The cross-reference may additionally reveal corresponding avatars that also compliment or conflict with the first avatar. For example, the first avatar may represent a graphic of a smiling person. Based on the cross-reference, control circuitry 304 may determine that other graphics of people with distinctive facial expressions corresponds to the first avatar (e.g., as all the avatars correspond to facial expressions). Furthermore, control circuitry 304 may also determine that graphics featuring positive facial expressions (e.g., smiles, laughs, kisses, etc.) may compliment the first avatar; however, graphics featuring negative facial expressions (e.g., sneers, growls, cries, etc.) may conflict with the first avatar. For example, while a graphic featuring a crying face shares a characteristic with the first avatar (e.g., both constitute a facial expression), a characteristic (e.g., the emotion represented by the face) of the graphic featuring the crying face also has a characteristic that opposes the first avatar.

Control circuitry 304 may determine a need to communicate information to a user, and may, based on the nature of the need, determine a graphic for use in communicating the information to the user. As an example, control circuitry 304 may receive a request from a user (e.g., via user input interface 310) of user equipment 300 to view a particular program, and may determine a need to communicate to the user that viewing the particular program would conflict with a user's habit of viewing a different program. Control circuitry 304 may identify an avatar that is well-suited to the information to be communicated by cross-referencing a database that lists correspondences between databased graphics and a user-selected graphic, and then use the identified avatar to communicate the information to the user.

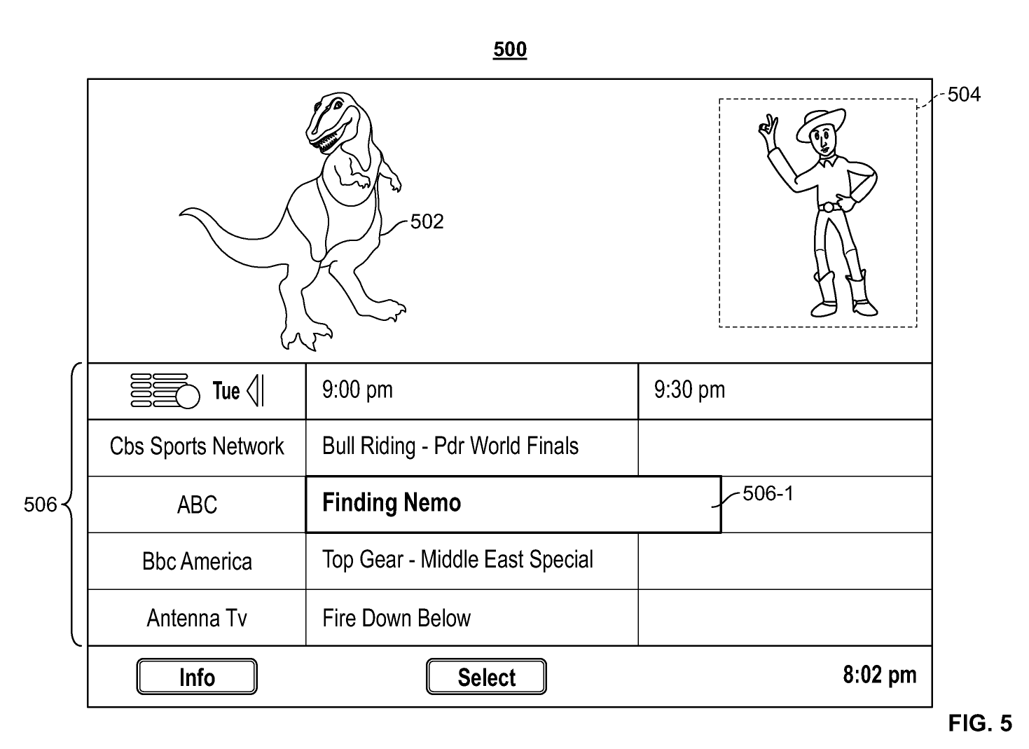

FIG. 5 shows an illustrative embodiment of a display screen that may be used to provide media guidance information by way of one or more avatars, in accordance with some embodiments of the disclosure. User equipment 500 may be a fixed equipment (e.g., a television or a personal computer) or a mobile equipment (e.g., a tablet, smartphone, laptop), or any other type of user equipment. User equipment 500 may utilize avatar 502 to communicate information to a user.

Avatar 502 may be selected manually or automatically. Manual selection of avatar 502 may occur in response to control circuitry 304 detecting a user selection of avatar 502 from a plurality of avatars. For example, avatar 502 may be selected from a menu of avatars, where control circuitry 304 causes the menu to be displayed through display 312. For example, a user who enjoys the movie “Toy Story” may select the character of Rex, a dinosaur, to be the user's avatar 502 for communicating information, and control circuitry 304 may receive this selection through user input interface 310 and cause the selection to be stored in storage 308. Rex may be included within a menu caused to be displayed by control circuitry 304 (e.g., through display 312) that includes other potential avatars, such as Woody and Zurg, which are also characters from the movie “Toy Story.” The menu caused to be displayed by control circuitry 304 may additionally or alternatively include various depictions of Rex (e.g., Rex wearing sunglasses or other accessories). The menu may be populated in response to control circuitry 304 querying a database (e.g., media guidance data source 418) via communications network 414, where the query requests information pertaining to potential avatars for the purpose of populating the menu.

As another example, control circuitry 304 may detect a selection of avatar 502 if a user interacts with a media asset that is currently displayed (e.g., on display 312). For example, if a user is watching “Toy Story” on wireless communications device 406, which may be a tablet device, and the user taps on the character Rex during a scene where Rex is displayed, control circuitry 304 may determine that a selection of Rex has been made. Control circuitry 304 may responsively allocate Rex as avatar 502, or may alternatively cause a prompt to be displayed on display 312 asking the user if the user would like to allocate Rex as the user's avatar. In such a scenario, if control circuitry 304 determines that the user has indicated a preference to allocate Rex as the user's avatar, Rex will be set as avatar 502.

As indicated above, in some embodiments, avatar 502 may be selected automatically by control circuitry 304. Control circuitry 304 may automatically select avatar 502 based on any number of factors, including user profile data (e.g., preferences, habits, and the like), time of day, mood of a user, present seasonal information (e.g., an avatar may be depicted as wearing a jacket or standing in snow if it is presently winter), and the like. Control circuitry 304 may also select avatar 502 automatically based on a presently or previously viewed media asset. For example, if a user is presently watching a football match, a football player such as Tom Brady may be automatically selected by control circuitry 304 to be avatar 502. Automatic selection may be based on any other criterion or criteria, including a detection by control circuitry 304 of a presently selected, highlighted, or cursored media asset identifier.

While avatar 502 is depicted as a graphic, in some embodiments avatar 502 communicates information through audio. For example, if avatar 502 is the character Rex from “Toy Story,” avatar 502 may not be a displayed graphic, and may instead be a voice that mimics the voice of Rex to convey information.

In some embodiments, control circuitry (e.g., control circuitry 304) of user equipment 500 may determine a need to communicate information to a user. In some embodiments, the need to communicate information to the user may be determined by control circuitry 304 based on a user interaction with user input interface 310. For example, control circuitry 304 may enable a user to navigate media asset identifiers 506. The navigation may occur via assistance by avatar 502, where media asset identifiers 506 may be caused to be displayed by control circuitry 304 in a manner where avatar 502 highlights certain media asset identifiers 506 based on characteristics of avatar 502. Control circuitry 304 may cause the navigational assistance of avatar 502 to include graphical assistance, audio assistance, or both. For example, if the character Rex from toy story is represented by avatar 502, control circuitry 304 may cause a graphic of Rex to appear to guide the user through media asset identifiers 506, and may alternatively or additionally utilize the voice of Rex to guide the user through media asset identifiers 506. In some embodiments, the navigation may occur without assistance by avatar 502.

In some embodiments, the need to communicate information to the user may be based on automatic detection by control circuitry 304 of an event or happenstance. For example, the need to communicate information to the user may occur when control circuitry 304 determines that fifteen minutes remain before parental control settings are to lock out a user, and may wish to alert the user of this occurrence. Other events and happenstances that may cause control circuitry 304 to determine a need to communicate information to the user automatically include a change in time, day, season, weather, a user's mood, an input from a biometric device (e.g. a biometric device that is external to the human body, such as an enhanced bracelet including a sensor, or a internal to the human body, such as an injected chip including a sensor or a pacemaker with enhanced capabilities), an action occurring within a media asset, a change in broadcast time of a scheduled media asset, a user-set conditional that has been met (e.g., a reminder or alert), and the like.

In some embodiments, in response to control circuitry 304 determining a need to communicate information to the user, a second avatar (e.g., avatar 504) may be selected by control circuitry 304 to communicate the information to the user. Control circuitry 304 may select second avatar 504 by first retrieving a first graphic (i.e., avatar 502) from a user profile. In order to retrieve the first graphic, control circuitry 304 may transmit a query to a database (e.g., media guidance data source 418) via communications network 414. Media guidance data source 418 may be local or remote to user equipment 300. Media guidance data source 418 may store avatars available for retrieval, or may point to locations where avatars may be retrieved. Media guidance data source 418 may similarly store user profiles and/or pointers to where user profiles may be retrieved.

Media guidance data source 418 may list correspondences between a plurality of graphics. For example, control circuitry 304 may transmit one or more characteristics of avatar 502 to media guidance data source 418 when sending the query. Media guidance data source 418 may cross-reference the characteristic of avatar 502 with characteristics of each graphic of the plurality of graphics that are databased at media guidance data source 418 in order to identify a match. As an example, if avatar 502 is Rex from the movie “Toy Story,” control circuitry (e.g., control circuitry 304) within media guidance data source 504 may cross-reference the characteristic “dinosaur,” which is a characteristic of the character, Rex, against entries in the database to determine one or more matching entries. Control circuitry 304 may alternatively or additionally cross-reference the characteristic, “Toy Story,” against the database to identify other characters from the movie, “Toy Story.”

To determine that two avatars correspond, control circuitry 304 may first determine one or more characteristics of an avatar. For example, control circuitry 304 may incorporate or have access to various components for detecting and distinguishing between characteristics of avatars (e.g., a video detection component, an audio detection component, object recognition module, etc.). For example, control circuitry 304 may access a content recognition module that uses object recognition techniques such as edge detection, pattern recognition, including, but not limited to, self-learning systems (e.g., neural networks), optical character recognition, on-line character recognition (including, but not limited to, dynamic character recognition, real-time character recognition, intelligent character recognition), and/or any other suitable technique or method to identify a characteristic of an avatar. For example, the media application may receive data in the form of a video animation of the avatar. The video may include a series of frames. For each frame of the video, the control circuitry may use a content recognition module or algorithm to detect the characteristics in each of the frames or series of frames.

In some embodiments, the content recognition module or algorithm may also include speech recognition techniques, including but not limited to Hidden Markov Models, dynamic time warping, and/or neural networks (as described above) to translate spoken words into text and/or processing audio data associated with the avatar.

In addition, the media application may use multiple types of optical character recognition and/or fuzzy logic, for example, when processing keyword(s) retrieved from data (e.g., textual data, translated audio data, user inputs, etc.) describing one or more characteristics of the avatar. For example, if the avatar includes textual data (e.g., a word, insignia, etc.), using fuzzy logic, the control circuitry (e.g., via a content recognition module or algorithm incorporated into, or accessible by, the media application) may determine two fields and/or values to be identical even though the substance of the data or value (e.g., two different spellings) is not identical.

Control circuitry 304 may input an identified characteristic of a first avatar into a database listing characteristics of avatars, and filter the database based on other avatars that have the same characteristics. Upon determining that the initial avatar shares one or more characteristics with an outputted avatar, control circuitry 304 may determine that the avatars correspond.

Additionally or alternatively, control circuitry 304 may input the characteristic into a database that indicate known associations of the characteristics. For example, if the characteristic of the avatar includes an insignia, the control circuitry may determine an origin of the insignia. For example, control circuitry 304 may input the insignia into a database that output a sports team associated with the insignia. Control circuitry 304 may then determine (e.g., based on one or more database cross-references) other information associated with the sports team (e.g., play names, leagues, mascots, etc.) in order to determine another avatar that corresponds to the initial avatar.

After determining that two avatars correspond, control circuitry 304 may determine whether the avatars compliment each other or conflict each other. Control circuitry may determine that the avatars compliment each other if one or more characteristics of the avatars match. For example, if the avatars were both protagonists in the same or different media assets, the characteristic of “protagonist” may indicate that the avatars compliment each other. Control circuitry may determine whether the avatars conflict by determining whether one or more characteristics of the avatars oppose one another. As an example, if the one of the avatars is of a protagonist in a media asset, and a different one of the avatars is of an antagonist in the same or a different media asset, the characteristics of “protagonist” and “antagonist” indicate that the avatars conflict.

When control circuitry 304 cross-references a characteristic of avatar 502 against entries in media guidance data source 418, control circuitry 304 may cross-reference characteristics of other data, such as those of a user profile or particular happenstance (as described above), in order to refine the result of the query sent to media guidance data source 418. In response to the query, control circuitry 304 may receive a response from media guidance data source 418 that indicates one or more matching data entries. Control circuitry 304 may, in the case that more than one data entry matches, determine a best match. For example, control circuitry 304 may identify all known characteristics of avatar 502 and determine which entry returned from media guidance data source 418 has the most characteristics in common with avatar 502. Control circuitry 304 may alternatively or additionally utilize characteristics of a user profile or those of any particular happenstance, as defined above, in order to determine a best match.

In some instances, control circuitry 304 may deem it desirable to select avatar 504 to be a character that is in conflict, or which complements, a character represented by avatar 502. Multiple avatars 504 may be selected in some circumstances. The following 3 examples that illustrate the selection of avatar 504 assume avatar 502 to represent the character Rex from the movie, “Toy Story.”

### Example 1

A user typically watches the cartoon, “Cowboys and Indians,” at 8:00 pm. At 8:02 pm, control circuitry 304 detects a user selection of the movie, “Finding Nemo,” when media asset identifier 506-1 is selected. Control circuitry 304 determines a need to inform the user that if the user watches, “Finding Nemo,” the user will miss tonight's airing of “Cowboys and Indians.” Because the user is taking an action that is in conflict with the user's typical activity, control circuitry 304 may select the character Zurg from “Toy Story” as avatar 504 to convey this conflict to the user and ask the user if s/he would like to view “Cowboys and Indians” instead of “Finding Nemo,” or ask the user if s/he would like to record “Cowboys and Indians.”

### Example 2

A user is presently viewing the media asset “Finding Nemo” at a time when control circuitry 304 determines that “Cowboys and Indians,” a media asset that the user typically views, is scheduled to air. Control circuitry 304 may select the character “Woody”—a friend of Rex in the movie “Toy Story”—as avatar 504 in order to communicate to the user that the user may wish to view “Cowboys and Indians” now that it is about to air.

### Example 3

User equipment 500 has parental controls set on it that prevent control circuitry 304 from allowing a user to view media after 9:30 pm. A user attempts to view the media asset “Finding Nemo,” which airs from 9:00 pm until 9:45 pm. Control circuitry 304 selects the character “Zurg,” who is in conflict with the user's avatar 502, to be avatar 504 for the purposes of communicating to the user that s/he will miss the last fifteen minutes of “Finding Nemo” due to parental control restrictions. A different avatar 504 that compliments Rex, such as the character Woody from “Toy Story,” may be selected to also appear to communicate to the viewer that s/he may record some or all of “Finding Nemo” and view the recorded portion at a future time that is not restricted by parental control settings.

Avatar 504 is selected by control circuitry 304 to communicate the information to the user once a match is determined by control circuitry 304. While avatar 504 is depicted as a graphic, avatar 504 may instead or additionally communicate the information to the user by way of audio communications (e.g., via speakers 314). In some embodiments, control circuitry 304 may detect a user input (e.g., via user input interface 310) to override the selected avatar. In some embodiments, control circuitry 304 may cause avatar 502 to communicate the information in response to detecting a user input to override avatar 504. In other embodiments, control circuitry 304 may prompt the user (e.g., via display 312) to select a different avatar 504 in response to detecting a user input to override avatar 504. In some embodiments, control circuitry 304 may cancel the communication of the information in response to detecting a user input to override avatar 504.

In some embodiments, avatar 502 may be caused to be generated for display by control circuitry 304 when the user publishes content through a social network. For example, when registering or updating a user profile on a social network, control circuitry 304 may determine a user selection of avatar 502 as an identifier or graphic associated with the user. In such an instance, avatar 502 may be caused by control circuitry 304 to be displayed near some or all content that the user publishes through the social network. Control circuitry 304 may determine that avatar 502 is selected by the user to uniquely identify the user on the social network.

As used herein, a “social network,” refers to a platform that facilitates networking and/or social relations among people who, for example, share interests, activities, backgrounds, and/or real-life connections. In some cases, social networks may facilitate communication between multiple user devices (e.g., computers, televisions, smartphones, tablets, etc.) associated with different users by exchanging content from one device to another via a social media server. As used herein, a “social media server” refers to a computer server that facilitates a social network. For example, a social media server owned/operated/used by a social media provider may make content (e.g., status updates, microblog posts, images, graphic messages, etc.) associated with a first user accessible to a second user that is within the same social network as the first user.

As described in the foregoing, in some embodiments control circuitry 304 may cross-reference the first graphic with a database listing correspondences between a plurality of graphics to determine a second graphic that corresponds to the first graphic. In some embodiments, control circuitry 304 may determine that the first graphic (e.g., avatar 502) corresponds with the second graphic (e.g., avatar 504) when the first graphic and the second graphic correspond to an identical media asset. For example, if avatar 502 is an avatar of the character Rex from “Toy Story,” control circuitry 304 may determine that Woody or Zurg from “Toy Story” should be depicted as avatar 504 because Woody and Zurg correspond to an identical media asset as Rex—namely, the movie “Toy story.”

In some embodiments, control circuitry 304 may determine that the first graphic (e.g., avatar 502) corresponds with the second graphic (e.g., avatar 504) when the first graphic and the second graphic correspond to an identical sport or sports entity. For example, if avatar 502 is an avatar of Eli Manning, a quarterback of the New York Giants football team, avatar 504 may be determined by control circuitry 304 to be a different American football player. As discussed in the foregoing, avatar 504 may compliment or conflict with avatar 502, and as such may be determined by control circuitry 304 to be a fellow teammate of Eli Manning, or a rival of Eli Manning.

In some embodiments, control circuitry 304 may determine that the first graphic (e.g., avatar 502) corresponds with the second graphic (e.g., avatar 504) when the first graphic and the second graphic correspond to an identical category of interests of the user. For example, if avatar 502 is an avatar of the character Rex from the movie “Toy Story,” control circuitry 304 may determine that Rex is a cartoon character, and may query media guidance data source 418 for a list of candidates for avatar 504 that are also cartoon characters.

In some embodiments, control circuitry 304 may determine a graphic for avatar 504 based on the type of information that control circuitry 304 needs to communicate. An information type may correspond to whether the information to be communicated is an alert (e.g., an alerting of a recording conflict), requested information (e.g., requested programming information), and the like. Control circuitry 304 may cross-reference the information type with entries of media guidance data source 418 to determine whether the information type matches an information type corresponding to the second graphic. If control circuitry 304 finds a match, then the second graphic may be selected by control circuitry 304 for communicating the information. As has been described above, if the information type is an alert of a conflict, the second graphic that corresponds to the information type may be set by control circuitry 304 to be a character that conflicts with the first graphic (e.g., select Zurg to announce the conflict if the user's avatar is Rex).

In some embodiments, control circuitry 304 may determine a graphic for avatar 504 based on a parental control. As an example, control circuitry 304 may determine that a parental control period includes a limit on what times of day a child may access the media guidance application. If avatar 502, the user's selected avatar, is Rex from “Toy Story,” and if a current time period is within a time restricted by the parental controls, avatar 504 may be set to be a conflicting avatar (e.g., Zurg) based on a correspondence in media guidance data source 418 regarding the restricted time period to communicate to the user that the user is not allowed to be utilizing the media guidance application at the current time.

In some embodiments, control circuitry 304 may determine a graphic for avatar 504 based on a current time period. For example, a second avatar may correspond to a first avatar based on the avatars appearing as characters in the same media assets. Control circuitry 304 may additionally ensure that the second avatar appears as the character currently does in the media asset. For example, the appearance of the character may have changed over time. Thus, control circuitry 304 may ensure that the second avatar appears as an up-to-date version of the character. To do this, control circuitry 304 may retrieve an attribute about the second avatar indicating a time period (e.g., a date range, a particular season of a series, etc.) to which the second avatar belongs. Control circuitry 304 may only select the second avatar if the time period for that avatar corresponds to the current time period or the time period associated with a user (e.g., if the user is currently in the second season of a media asset, control circuitry may select a second avatar that corresponds to the second season, irrespective if the second season is the current season).

In some embodiments, control circuitry 304 may generate an avatar locally based on a media asset being consumed by a user. For example, while a user is viewing a video asset, control circuitry 304 may select an avatar from the video asset and render an image of the avatar locally. In some embodiments, control circuitry 304 may identify the video asset being viewed and may retrieve an image of the avatar from a remote database such as media guidance data source 418. In some embodiments, the rendered or retrieved avatar may reflect a present state of a character in the video asset (e.g., may wear the same clothes or have the same facial expression as a character in the video asset during any particular scene).

While the disclosure above and below illustrates the figures by describing how avatars 502 and 504 are utilized to enhance the media guidance experience in the context of programming, avatars 502 and 504 may also be utilized to enhance the media guidance experience with relation to product inquiries. For example, if control circuitry 304 detects a selection of a product identifier or an advertisement, control circuitry 304 may query media guidance data source 418 to learn of information that would inform a consumer's decision to purchase an associated product. For example, if a product has negative reviews, control circuitry 304 may select an avatar 504 that conflicts with avatar 502 to inform the user that it would be ill-advised to purchase the product.

In some embodiments, control circuitry 304 may determine a need to communicate information to a user, such as the fact that a requested recording will conflict with a scheduled recording. In response to determining the need to communicate information to the user, control circuitry 304 may access a user profile that corresponds to the user to retrieve a first graphic from the user profile such as the user's avatar (e.g., avatar 502). For example, the user's avatar might be the character Rex from the movie “Toy Story.” Control circuitry 304 may cross-reference the first graphic against a database (e.g., media guidance data source 418) to determine a second graphic that corresponds to the first graphic (e.g., avatar 504). Avatar 504 may be a graphic that conflicts with avatar 502, such as Zurg from “Toy Story,” or a graphic that compliments avatar 502, such as Woody from “Toy Story,” both of which have been described in further detail above. Avatar 504, as selected by control circuitry 304, may be utilized to communicate the information to the user (e.g., via display 312 or speakers 314).

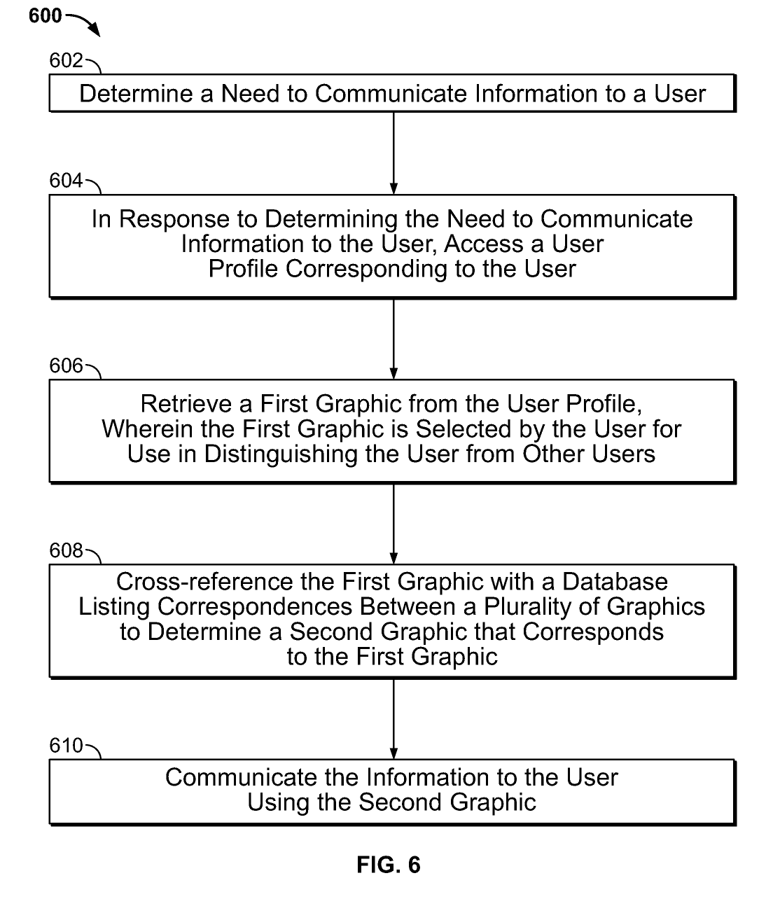

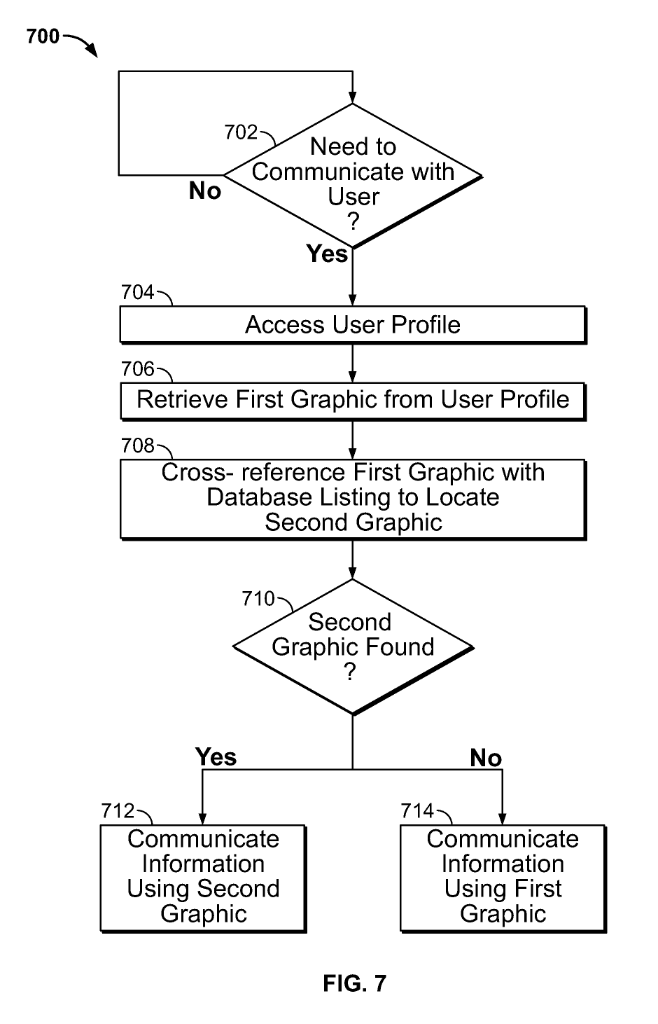

FIG. 6 is a flowchart of illustrative steps for determining an avatar for use in communicating information to a user. It should be noted that process 600 or any step thereof could be performed on, or provided by, any of the devices shown in FIGS. 3-4. For example, process 700 may be executed by control circuitry 304 (FIG. 3) as instructed by control circuitry implemented on user equipment 402, 404, and/or 406 (FIG. 4) in order to determine an avatar for use in communicating information to a user. In addition, one or more steps of process 600 may be incorporated into or combined with one or more steps of any other process or embodiment (e.g., process 700 (FIG. 7)).

Process 600 begins at 602, where control circuitry 304 may determine a need to communicate information to a user. As described above, the need to communicate information to the user may be automatic or based on a current user interaction with a media guidance application presently accessible via user equipment (e.g., user equipment 500). In some embodiments, a user may select media asset identifier 506-1 in an effort to tune to the media asset “Finding Nemo.” Control circuitry 304 may determine that the user typically views the media asset “Cowboys and Indians” at the current time, and may determine a need to communicate to the user that if the user tunes to the media asset “Finding Nemo,” the user will miss an airing of the media asset “Cowboys and Indians.”

Process 600 continues at 604, where, in response to determining the need to communicate information to the user, control circuitry 304 accesses a user profile corresponding to the user. Control circuitry 304 may access the user profile locally (e.g., at storage 308), or remotely (e.g., at media guidance data source 418) via communications network 414.

Process 600 continues at 606, where control circuitry 304 causes a first graphic (e.g., avatar 502) to be retrieved from the user profile. As described above, the first graphic may be user-selected or automatically selected by control circuitry 304. As an example, control circuitry 304 may detect a user selection of the character Rex to be the first graphic (i.e., avatar 502) if a user, using a wireless communications device 406, taps on the character Rex while the movie “Toy Story” is playing on the wireless communications device 406. The selection of the character Rex as avatar 502 may be stored in the user profile (e.g., at storage 308) for retrieval by control circuitry 304 when determining what avatar to select for avatar 504. Optionally, the first graphic may be selected by the user for use in distinguishing the user from other users (e.g., in the context of social networking).

Process 600 continues at 608, where control circuitry 304 cross-references the first graphic with a database (e.g., media guidance data source 418) that lists correspondences between the plurality of graphics to determine a second graphic that corresponds to the first graphic. Control circuitry 304 may cross-reference the first graphic with media guidance data source 418 (i.e., the database of 608) by transmitting a query to media guidance data source 418 via communications network 414. Control circuitry 304 may receive matching entries and determine one or more second graphics that correspond to the first graphic, and therefrom select an avatar 504. As described above, control circuitry 304 may determine avatar 504 to be a particular graphic that compliments or conflicts with avatar 502.

Process 600 continues at 610, where control circuitry 304 communicates the information to the user using the second graphic. As described above, control circuitry 304 may cause avatar 504 to display the information (e.g., via display 312), output the information audibly, perhaps in a voice that is representative of the selected graphic (e.g., via speakers 314), or a combination of the two.

In some embodiments, control circuitry 304 may determine a need to communicate information to a user, such as information pertaining to a media asset identifier that is selected by a user. In response to determining the need to communicate information to the user, control circuitry 304 may access a user profile that corresponds to the user to retrieve a first graphic from the user profile such as the user's avatar (e.g., avatar 502). For example, the user's avatar might be the character Rex from the movie “Toy Story.” Control circuitry 304 may cross-reference the first graphic against a database (e.g., media guidance data source 418) to determine a second graphic that corresponds to the first graphic (e.g., avatar 504). In some instances, where a second graphic is not found, control circuitry 304 may communicate information using the first graphic.

It is contemplated that the steps or descriptions of FIG. 6 may be used with any other embodiment of this disclosure. In addition, the steps and descriptions described in relation to FIG. 6 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 3-4 could be used to perform one or more of the steps in FIG. 6.

FIG. 7 is a flowchart of illustrative steps for determining whether to use a user-selected or automatically-selected avatar to communicate information. It should be noted that process 700 or any step thereof could be performed on, or provided by, any of the devices shown in FIGS. 3-4. For example, process 700 may be executed by control circuitry 304 (FIG. 3) as instructed by control circuitry implemented on user equipment 402, 404, and/or 406 (FIG. 4) in order to determine whether to use a user-selected or automatically-selected avatar to communicate information. In addition, one or more steps of process 700 may be incorporated into or combined with one or more steps of any other process or embodiment (e.g., process 600 (FIG. 6)).

Process 700 begins at 702, where control circuitry 304 may determine a need to communicate information to a user. As described above, the need to communicate information to the user may be automatic or based on a current user interaction with a media guidance application presently accessible via user equipment (e.g., user equipment 500). In some embodiments, a user may select media asset identifier 506-1 in an effort to find out more information about the media asset “Finding Nemo.” Control circuitry 304 may responsively determine a need to communicate the additional information to the user.

Process 700 continues at 704, where, in response to determining the need to communicate information to the user, control circuitry 304 accesses a user profile corresponding to the user. Control circuitry 304 may access the user profile locally (e.g., at storage 308), or remotely (e.g., at media guidance data source 418) via communications network 414.

Process 700 continues at 706, where control circuitry 304 causes a first graphic (e.g., avatar 502) to be retrieved from the user profile. As described above, the first graphic may be user-selected or automatically selected by control circuitry 304. As an example, control circuitry 304 may detect a user selection of the character Rex to be the first graphic (i.e., avatar 502) if a user, using a wireless communications device 406, taps on the character Rex while the movie “Toy Story” is playing on the wireless communications device 406. The selection of the character Rex as avatar 502 may be stored in the user profile (e.g., at storage 308) for retrieval by control circuitry 304 when determining what avatar to select as avatar 504. Optionally, the first graphic may be selected by the user for use in distinguishing the user from other users (e.g., in the context of social networking).

Process 700 continues at 708, where control circuitry 304 cross-references the first graphic with a database (e.g., media guidance data source 418) that lists correspondences between the plurality of graphics to determine a second graphic that corresponds to the first graphic. Control circuitry 304 may cross-reference the first graphic with media guidance data source 418 (i.e., the database of 708) by transmitting a query to media guidance data source 418 via communications network 414. Control circuitry 304 may receive matching entries and determine one or more second graphics that correspond to the first graphic, and therefrom select an avatar 504. As described above, control circuitry 304 may determine avatar 504 to be a particular graphic that compliments or conflicts with avatar 502.

Process 700 continues at 710, where control circuitry 304 determines whether a second graphic was found. Control circuitry 304 may determine that a second graphic was found if a second graphic that corresponds to the graphic of avatar 502 was found. Control circuitry 304 may additionally determine whether the user's media guidance experience would be enhanced by the introduction of a second avatar 504 for the purposes of communicating the information to the user, and may determine to that a second graphic was not found if the second graphic is not determined to enhance the media guidance experience of the user.

Process 700 continues to 712 if a second graphic is found, and continues to 714 if a second graphic is not found. At 712, control circuitry 304 communicates the information to the user using the second graphic. As described above, control circuitry 304 may cause avatar 504 to display the information (e.g., via display 312), output the information audibly, perhaps in a voice that is representative of the selected graphic (e.g., via speakers 314), or a combination of the two. At 714, control circuitry 304 will cause avatar 502 to communicate the information. As an example, control circuitry 304 may determine that a second graphic should not be used to communicate the information using a second avatar 504 in the instance where a user is simply seeking further information about media guidance data that is already being presented using avatar 502, as a complimentary or conflicting avatar would not enhance the delivery of this information.

It will be apparent to those of ordinary skill in the art that methods involved in the present invention may be embodied in a computer program product that includes a computer usable and/or readable medium. For example, such a computer usable medium may consist of a read-only memory device, such as a CD-ROM disk or conventional ROM devices, or a random access memory, such as a hard drive device or a computer diskette, having a computer readable program code stored thereon. It should also be understood, that methods, techniques, and processes involved in the present invention may be executed using processing circuitry. For instance, determination of which avatar 504 is to be used to communicate information to a user may be performed by processing circuitry, e.g., by processing circuitry 306 of FIG. 3. The processing circuitry, for instance, may be a general purpose processor, a customized integrated circuit (e.g., an ASIC), or a field-programmable gate array (FPGA) within user equipment 300, media content source 416, or media guidance data source 418. For example, the user profile information as described herein may be stored in, and retrieved from, storage 308 of FIG. 3, or media guidance data source 418 of FIG. 4. Furthermore, processing circuitry, or a computer program, may update settings associated with a user, such as a selected avatar 502, updating the information stored within storage 308 of FIG. 3 or media guidance data source 418 of FIG. 4.

It is contemplated that the steps or descriptions of FIG. 7 may be used with any other embodiment of this disclosure. In addition, the steps and descriptions described in relation to FIG. 7 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 3-4 could be used to perform one or more of the steps in FIG. 7.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted, the systems and/or methods described above may be applied to, or used in accordance with, other systems and/or methods.

1. A method comprising:
determining a need to communicate information to a user;
in response to determining the need to communicate information to the user, accessing a user profile corresponding to the user;
retrieving a first graphic from the user profile;
cross-referencing the first graphic with a database listing correspondences between a plurality of graphics to determine a second graphic that corresponds to the first graphic; and
communicating the information to the user using the second graphic.

2. The method of claim 1, further comprising determining the need to communicate information to the user based on receiving a user request for the information.

3. The method of claim 1, wherein the first graphic is generated for display when the user publishes content through a social network.

4. The method of claim 3, wherein the first graphic is selected by the user for use in distinguishing the user from other users.

5. The method of claim 1, wherein the first graphic corresponds to the second graphic when the first graphic and the second graphic both correspond to an identical media asset.

6. The method of claim 1, wherein the first graphic corresponds to the second graphic when the first graphic and the second graphic correspond to an identical sport.

7. The method of claim 1, wherein the first graphic corresponds to the second graphic when the first graphic and the second graphic correspond to an identical category of interests of the user.

8. The method of claim 1, further comprising:
determining a characteristic of the first graphic;
comparing the characteristic to characteristics of the second graphic; and
determining the second graphic corresponds to the first graphic based in response to determining the characteristic matches one of the characteristics.

9. The method of claim 1, further comprising:
determining an information type of the information;
cross-referencing the information type with a database listing information types corresponding to the second graphic to determine whether the information type matches one of the information types corresponding to the second graphic; and
selecting the second graphic to communicate the information to the user in response to determining the information type matches one of the information types corresponding to the second graphic.

10. The method of claim 1, further comprising:
determining a current time period;
cross-referencing the current time period with a database listing time periods corresponding to the second graphic to determine whether the current time period matches one of the time periods corresponding to the second graphic; and
selecting the second graphic to communicate the information to the user in response to determining the current time period matches one of the time periods corresponding to the second graphic.

11. A system comprising:
storage circuitry for storing a database listing correspondences between a plurality of graphics; and
control circuitry configured to:
determine a need to communicate information to a user;
in response to determining the need to communicate information to the user, access a user profile corresponding to the user;
retrieve a first graphic from the user profile;
cross-reference the first graphic with the database listing correspondences between a plurality of graphics to determine a second graphic that corresponds to the first graphic; and
communicate the information to the user using the second graphic.

12. The system of claim 11, wherein the control circuitry is further configured to determine the need to communicate information to the user based on receiving a user request for the information.

13. The system of claim 11, wherein the first graphic is generated for display when the user publishes content through a social network.

14. The system of claim 13, wherein the first graphic is generated for display when the user publishes content through a social network.

15. The system of claim 11, wherein the first graphic corresponds to the second graphic when the first graphic and the second graphic both correspond to an identical media asset.

16. The system of claim 11, wherein the first graphic corresponds to the second graphic when the first graphic and the second graphic correspond to an identical sport.

17. The system of claim 11, wherein the first graphic corresponds to the second graphic when the first graphic and the second graphic correspond to an identical category of interests of the user.

18. The system of claim 11, wherein the control circuitry is further configured to:
determine a characteristic of the first graphic;
compare the characteristic to characteristics of the second graphic; and
determine the second graphic corresponds to the first graphic based in response to determining the characteristic matches one of the characteristics.

19. The system of claim 11, wherein the control circuitry is further configured to:
determine an information type of the information;
cross-reference the information type with a database listing information types corresponding to the second graphic to determine whether the information type matches one of the information types corresponding to the second graphic; and
select the second graphic to communicate the information to the user in response to determining the information type matches one of the information types corresponding to the second graphic.

20. The system of claim 11, wherein the control circuitry is further configured to:
determine a current time period;
cross-reference the current time period with a database listing time periods corresponding to the second graphic to determine whether the current time period matches one of the time periods corresponding to the second graphic; and
select the second graphic to communicate the information to the user in response to determining the current time period matches one of the time periods corresponding to the second graphic.

21-50. (canceled)
